(19) United States
(12) Patent Application Publication
(10) Pub. No.: US 2012/0137907 A1
(43) Pub. Date: Jun. 7, 2012

(54) INTAGLIO PRINTING PLATE INCLUDING SUPPLEMENTARY PATTERN AND METHOD FOR FABRICATING THE SAME

(75) Inventors: Ye Sul JEONG, Pohang (KR); Kyu-Ha Baek, Daejeon (KR); Lee-Mi Do, Daejeon (KR); Ji Man Park, Daejeon (KR); Kunsik Park, Daejeon (KR); Dong-Pyo Kim, Daejeon (KR); Zin Sig Kim, Daejeon (KR); Joo Yeon Kim, Daejeon (KR)

(73) Assignee: Electronics and Telecommunications Research Institute, Daejeon (KR)

(21) Appl. No.: 13/310,551

(22) Filed: Dec. 2, 2011

(30) Foreign Application Priority Data
Dec. 3, 2010 (KR) 10-2010-0122740

(51) Int. Cl. B41N 1/06

(52) U.S. Cl. 101/395

(57) ABSTRACT

Disclosed is an intaglio printing plate including: a pattern portion where a to-be-printed pattern is located; a non-pattern portion corresponding to a remaining area other than the pattern portion; and a supplementary pattern portion having a repetitive pattern with a predetermined form, wherein at least a part of the pattern portion is divided by a pattern structure that is formed by the supplementary pattern portion.

### CROSS-REFERENCE TO RELATED APPLICATIONS

This application is based on and claims priority from Korean Patent Application No. 10-2010-0122740, filed on Dec. 3, 2010, with the Korean Intellectual Property Office, the disclosure of which is incorporated herein in its entirety by reference.

### BACKGROUND OF THE INVENTION

1. Field of the Invention

The present invention relates to an intaglio printing plate including a supplementary pattern, and a method for fabricating the same. More particularly, the present invention relates to an intaglio printing plate formed with a supplementary pattern for enhancing ink filling efficiency and effectively forming a pattern when fine pattern printing is performed, and a method for fabricating such a supplementary pattern.

2. Description of the Prior Art

Conventionally, in order to manufacture a thin film transistor, a color filter, or a black matrix for use in a display apparatus, a photoresist pattern is formed by a photolithography method using exposure and etching processes. However, such a method of forming a photoresist pattern requires a high manufacturing cost due to the use of expensive equipment, and also involves complex manufacturing processes. In particular, there is a problem in that a plurality of photolithography processes must be repeatedly performed through screen splitting and be combined with each other in order to manufacture a large-area display device in wide use today.

Accordingly, a method has recently been proposed to form a pattern on a display device by a gravure offset printing technique without an exposure process. In the gravure offset printing technique, a series of processes are performed, that is, an intaglio printing plate formed with a pattern corresponding to a pattern to be formed on a substrate, for example, an intaglio groove, is filled with ink, the excess ink is scraped off using a tool called a doctor blade, the ink filled in the intaglio printing plate is transferred onto an offset roll, and then the ink on the offset roll is transferred onto the substrate again. Much research is being conducted to apply the gravure offset printing technique to active devices of display apparatuses and various circuit pattern formation processes.

However, the conventional gravure offset printing technique has some problems.

Firstly, the conventional gravure offset printing technique causes the following problem in the process of using a doctor blade for ink filling: The gravure offset printing includes a process of filling a pattern with ink and a process of scraping off the excess ink by using a doctor blade. According to the conventional gravure offset printing technique, a pattern arranged in a direction parallel to the printing direction, that is, the travel direction of the doctor blade, achieves high ink filling efficiency, but a pattern arranged in any other direction, for example, a direction perpendicular to the printing direction (i.e., a direction parallel to the longitudinal direction of the doctor blade) or a direction oblique to the printing direction, has difficulty in performing the ink filling process or the excess ink removal process. This is because, in the process of supplying a given amount of ink into a groove engraved in an intaglio printing plate while moving the whole intaglio printing plate in a state where the doctor blade comes into contact with the upper surface of the intaglio printing plate, the doctor blade that moves forward past a pattern formed horizontal to the longitudinal direction of the doctor blade is caught in the groove of the pattern, and thus the groove cannot be properly filled with the ink. Consequently, there may be a difference in the precision of a line width, a shape, and the like according to printing directions.

Secondly, the conventional gravure offset technique causes the following problem in the process of transferring ink by using an offset roll or a transfer roll: It is preferable to form a uniform pattern through a uniform pressure in the process of transferring ink onto a to-be-printed substrate while placing an intaglio printing plate, the groove of which is filled with the ink, on the substrate, but it is very difficult to form such a uniform pattern, depending on the shape or area of the pattern. According to the conventional gravure offset printing technique, when the ratio of a patterned portion to the remaining non-patterned portion is too low, sagging, which is an effect where the middle of the non-patterned portion is bent downward, is caused by a pressure applied in the process of pressing an intaglio printing plate by applying the pressure in order to transfer a desired pattern, and thus undesired pattern transfer may occur in the non-patterned portion. Further, a decrease in a gap between patterns and an increase in the width and height of a pattern lead to pairing that is an effect where separate patterns printed during ink transfer stick together. In addition, when a pattern is printed, ink transfer is not properly achieved at edges of the pattern due to the characteristics of ink, which causes a problem in that a pattern groove cannot be uniformly filled with the ink.

### SUMMARY OF THE INVENTION

Accordingly, the present invention has been made to solve the above-mentioned problems occurring in the conventional printing processes, and an object of the present invention is to provide an intaglio printing plate including a supplementary pattern that makes it possible to fill a pattern of the intaglio printing plate with ink regardless of the direction of the pattern, improve pattern separation properties, and finely control the transfer position of the ink.

In accordance with an aspect of the present invention, there is provided an intaglio printing plate including: a pattern portion where a to-be-printed pattern is located; a non-pattern portion corresponding to a remaining area other than the pattern portion; and a supplementary pattern portion having a repetitive pattern with a predetermined form. Here, at least a part of the pattern portion may be divided by a pattern structure that is formed by the supplementary pattern portion.

In accordance with another aspect of the present invention, there is provided an intaglio printing plate including: a pattern portion where a to-be-printed pattern is located; a non-pattern portion corresponding to a remaining area other than the pattern portion; and at least one supplementary pattern formed in the non-pattern portion. Here, the supplementary pattern may be configured such that a pressure applied by a doctor blade moving in the non-pattern portion during ink filling is concentrated into the supplementary pattern.

In accordance with yet another aspect of the present invention, there is provided an intaglio printing plate including: a pattern portion where a to-be-printed pattern is located; a non-pattern portion corresponding to a remaining area other than the pattern portion; a first supplementary pattern portion adjoining an outside of a convex corner part of the pattern portion and located in an area of the non-pattern portion; and a second supplementary pattern portion adjoining an inside of a concave corner part of the pattern portion and located in an area of the pattern portion. Here, the first supplementary pattern portion may be configured to be filled with ink, and the second supplementary pattern portion may be configured not to be filled with ink.

### BRIEF DESCRIPTION OF THE DRAWINGS

The above and other objects, features and advantages of the present invention will be more apparent from the following detailed description taken in conjunction with the accompanying drawings, in which:

FIG. 1 is a sectional view of an intaglio printing plate including a pattern portion and a non-pattern portion;

FIG. 2A is a sectional view of an intaglio printing plate including a pattern portion, which includes a supplementary pattern, according to an embodiment of the present invention;

FIG. 2B is a plan view illustrating a structure of the supplementary pattern portion shown in FIG. 2A;

FIG. 2C is a longitudinal sectional view of the pattern portion patterned with the supplementary pattern, shown in FIG. 2A;

FIG. 3 is a longitudinal sectional view of a pattern portion formed with a supplementary pattern according to another embodiment of the present invention;

FIGS. 4A to 4D are plan views illustrating structures of a supplementary pattern according to various embodiments of the present invention;

FIG. 5 is a sectional view of an intaglio printing plate including a non-patterned portion, which includes a supplementary pattern, according to an embodiment of the present invention; and

FIG. 6 is a sectional view of an intaglio printing plate including a pattern portion, which includes supplementary patterns in the vicinity of edges thereof, according to an embodiment of the present invention.

### DETAILED DESCRIPTION OF THE PREFERRED EMBODIMENTS

Hereinafter, embodiments of the present invention will be described with reference to the accompanying drawings. The technical constructions and operational effects of the present invention will be more clearly understood from the following detailed description. In the following description and drawings, the same reference numerals are used to designate the same or similar components, and so repetition of the description on the same or similar components will be omitted.

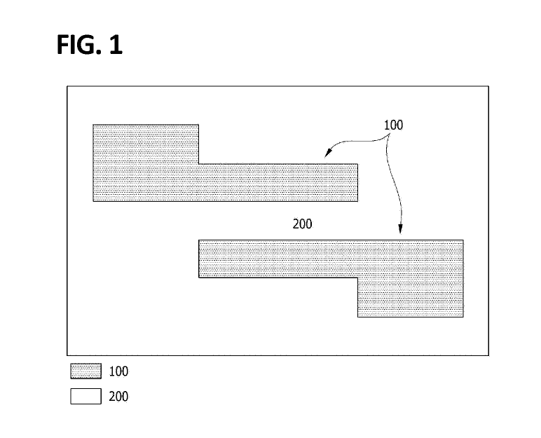

FIG. 1 is a sectional view illustrating an example of an intaglio printing plate including a pattern portion and a non-pattern portion. The pattern portion 100 means a portion where a pattern to be printed is patterned, and is represented by a shaded portion in FIG. 1. The non-pattern portion 200 means a portion that is not patterned, and represents an area other than the pattern portion 100 in FIG. 1.

A procedure of printing a pattern by the conventional gravure offset printing technique using the intaglio printing plate of FIG. 1 is as follows: First of all, the pattern portion 100 of the intaglio printing plate is formed with an intaglio groove, and the groove of the pattern portion 100 is filled with ink. Hereinafter, the ink refers to a variety of organic materials including color registers. In the process of filling the groove with the ink, the excess ink on the surface of the intaglio printing plate is scraped off by using a doctor blade that is a tool for removing unnecessary ink. Subsequently, the ink filled in the pattern portion 100 is transferred onto a to-be-printed matter, such as a substrate, by using a tool, such as a transfer roll, or by directly applying a pressure, and then the solvent of the ink is dried through a drying hood.

In the process of filling the groove of the pattern portion with the ink by using the doctor blade, when the doctor blade moves past a pattern formed horizontal to the longitudinal direction of the doctor blade, there is a problem in that the doctor blade is caught in the groove of the pattern, and thus the groove cannot be properly filled with the ink. Also, there are other problems including sagging that is caused by a pressure generated on both sides of a wide non-pattern portion, pairing, that is, sticking together of separate patterns during ink transfer due to the characteristics of the ink, and uneven ink filling at the boundary of a pattern.

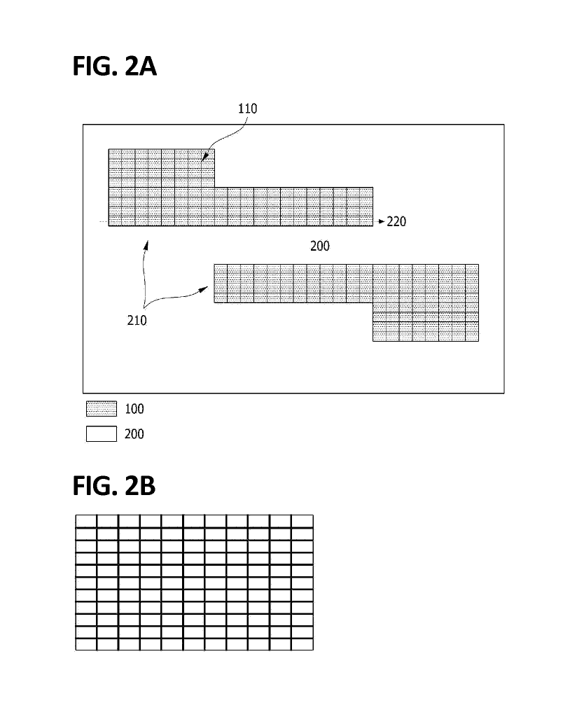

FIG. 2A is a sectional view of an intaglio printing plate with a supplementary pattern formed in the pattern portion 100 of FIG. 1 according to an embodiment of the present invention. FIG. 2A shows a pattern portion 210 including a supplementary pattern portion where a supplementary pattern 110 finer than the pattern portion 100 is repeatedly formed in order to improve the precision of the originally formed pattern portion 100.

FIG. 2B is a plan view of the supplementary pattern portion where the supplementary pattern 110 is repeatedly formed. As shown in FIG. 2B, the supplementary pattern portion has a mesh pattern in a rectangular structure. The supplementary pattern portion is in the form of the repetitive supplementary pattern 100 having a rectangular unit structure with predetermined horizontal and vertical lengths, and a plurality of the supplementary patterns 100 may be formed in the pattern portion 100 because the size of the supplementary pattern 110 is fine as compared to the length or width of the pattern portion 100.

FIG. 2C is a sectional view illustrating the inside of the pattern portion 210 including the supplementary pattern portion, as taken in the longitudinal direction of the pattern portion 210, and shows a situation where the groove of the pattern portion 100 formed with the supplementary pattern 110 is filled with ink 240 by using a doctor blade 230.

Referring to FIG. 2C, the supplementary pattern 110 repeated in the same form is embossed in the groove of the pattern portion 100, which is formed in an intaglio structure, and thus the pattern portion 100 may be divided into several fine pattern cells. The supplementary pattern 110 may be configured in the form of thin posts repeatedly arranged at regular intervals, and the height of the supplementary pattern 110 is the same as that of the pattern portion 100. In this way, by forming the supplementary pattern 110 in the pattern portion 100, the pattern portion 210 including the supplementary pattern portion has a fine structure without deformation of the pattern portion 100. During gravure offset printing, the intaglio printing plate is supplied with a given amount of ink to fill the groove of the pattern with the ink, and the residual ink left on the non-pattern portion is removed through the doctor blade 230. Referring to FIG. 2C, since the fine supplementary pattern 110 is repeatedly arranged in the pattern portion 100 to form fine patterns in up-and-down and left-and-right directions in the pattern portion 100, the doctor blade 230 is prevented from being caught in the groove of the pattern portion 100 during its movement. Accordingly, the doctor blade 230 can effectively remove the residual ink regardless of the printing direction, that is, the moving direction of the doctor blade 230. In this way, the pattern portion 210 including the supplementary pattern portion solves the problem of a change in the line width and shape of the transferred pattern, which is caused by the fact that the doctor blade is caught in the groove of the pattern in the process of removing the residual ink when the longitudinal direction of the doctor blade is horizontal to the pattern direction.

However, when the intaglio printing plate including the pattern portion 210 formed with the supplementary pattern is used to fill the pattern with the ink 240 and then transfer the pattern onto the substrate, the interruption of a linear pattern may be caused by a portion that is not filled with the ink 240 due to the supplementary pattern 110.

This problem of the interruption of a linear pattern can be solved by finely forming the width of the supplementary pattern 110. The fine width of the supplementary pattern 110 intentionally induces pairing that is an effect where printed ink lumps when a uniform pressure is applied to the intaglio printing plate filled with the ink in order to transfer the pattern of the intaglio printing plate onto the substrate, thereby allowing the pattern finally transferred to the substrate to be continuously formed without the interruption.

The width, shape, area, groove depth, and the like of the supplementary pattern 110 may be appropriately determined in consideration of the viscosity and surface energy of the ink 240 to be used, and the like. For example, when the viscosity and surface energy of the used ink 240 are high, the width and area of the supplementary pattern 110 may be relatively large. Contrarily, when the viscosity and surface energy of the supplementary pattern 110 are low, the width and area of the supplementary pattern 110 must be relatively small. Further, the surface of the supplementary pattern 110, which comes into contact with the doctor blade 230 during the ink filling process, may be made of the same material as that of the non-pattern portion 200.

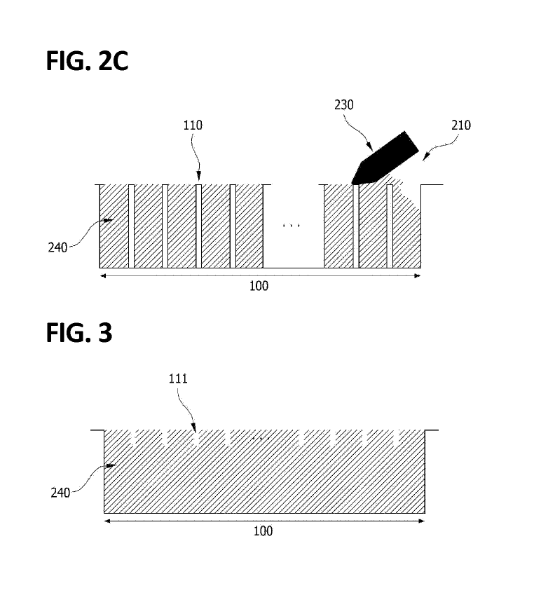

FIG. 3 is a longitudinal sectional view of a pattern portion formed with a supplementary pattern according to another embodiment of the present invention. The supplementary pattern 111 shown in FIG. 3 is formed only in the upper part of the groove of the pattern portion 100. While the height of the supplementary pattern 110 shown in FIG. 2C is the same as that of the groove of the pattern portion 100 and therefore all of the upper and lower parts of the pattern portion 100 are divided by the supplementary pattern 110, the supplementary pattern 111 shown in FIG. 3 is arranged only in the upper part of the groove of the pattern portion 100, with the result that the lower part of the groove of the pattern portion 100 is continuous without being divided, and only the upper part of the groove of the pattern portion 100 adjacent to the surface of the intaglio printing plate is divided by the supplementary pattern 111.

The supplementary pattern 111 formed in the upper part of the pattern portion 100, as shown in FIG. 3, may be concavely engraved in the form of an intaglio from the surface of the intaglio printing plate. Since the supplementary pattern 111 formed in the upper part of the pattern portion 100 is not embossed from the bottom of the groove of the pattern portion 100, it may be formed in such a manner that the upper part of groove of the pattern portion 100 is covered with a pattern structure, such as a cubic mesh. This pattern structure includes a plurality of the supplementary patterns 111 engraved in the form of an intaglio toward the bottom of the groove of the pattern portion 100.

The width, shape, area, groove depth, and the like of the supplementary pattern 111 may be appropriately determined in such a manner that the pattern finally transferred onto the substrate is continuously formed without any interruption, in consideration of the characteristics (e.g., viscosity and surface energy) of ink to be used, the depth of the supplementary pattern 111, and the like. Also, the width of the supplementary pattern 111 must be relatively small when the depth of the supplementary pattern 111 is deep, and must be relatively large when the depth of the supplementary pattern 111 is shallow.

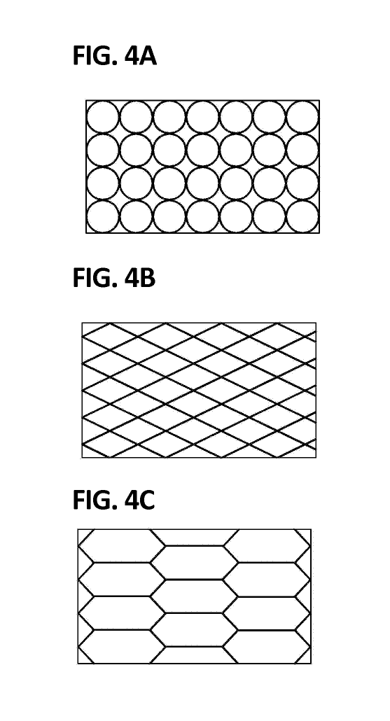

FIGS. 4A to 4D are plan views illustrating structures of a supplementary pattern portion according to various embodiments of the present invention. Each supplementary pattern portion shown in FIGS. 4A to 4D has a mesh pattern in which the same structure is repeatedly formed in up-and-down and left-and-right directions.

The mesh pattern of FIG. 4A is of a form in which a circular unit structure is repeated in a line in up-and-down and left-and-right directions. The mesh pattern of FIG. 4B is of a form in which a rhombic unit structure is repeated adjacent to each other. The mesh pattern of FIG. 4C is of a form in which a hexagonal unit structure is repeated adjacent to each other to form a honeycomb structure. The mesh pattern of FIG. 4D is of a form in which a hexagonal unit structure is repeated in a line in up-and-down and left-and-right directions.

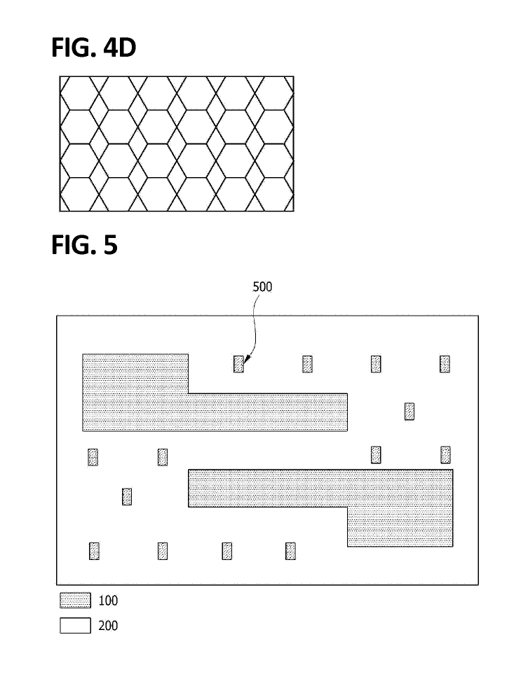

FIG. 5 is a sectional view of an intaglio printing plate including a non-pattern portion, which includes a supplementary pattern, according to an embodiment of the present invention. FIG. 5 shows a plurality of supplementary patterns 500 that are formed not in the pattern portion 100, but in the non-pattern portion 200.

Since the area of the non-pattern portion 20 is generally wider than that of the pattern portion 100, the residual ink may not be properly removed on the non-pattern portion 200 when the doctor blade 230 removes the residual ink. If the residual ink on the non-pattern portion 200 is not removed in this way, then patterns may be transferred onto unnecessary portions during the pattern transfer process, and thus the resultant pattern circuit may not function properly.

However, when the supplementary patterns 500 are appropriately arranged at regular intervals in the non-pattern portion 200, as shown in FIG. 5, an effect is achieved in which the wide non-pattern portion 200 has finer patterns by the formation of the supplementary patterns 500. For example, in the case of gravure offset printing for the pattern portion 100 engraved in the form of an intaglio, the supplementary patterns 500 in the non-pattern portion 200 may also be engraved in the form of an intaglio in the same manner as the pattern portion 100. In this way, a pressure is concentrated into the supplementary patterns 500 arranged at regular intervals in the non-pattern portion 200 when the doctor blade 230 removes the residual ink on the non-pattern portion 200 with a wide area, which allows the doctor blade 230 to effectively remove the residual ink.

However, when the pattern is transferred onto the substrate by using the intaglio printing plate including the non-pattern portion 200 formed with the supplementary patterns 500, pattern transfer may occur in the non-pattern portion 200 due to ink filled in grooves of the supplementary patterns 500. Accordingly, positions where the supplementary patterns 500 are formed in the non-pattern portion 200 must be so determined as not to affect the function of the pattern circuit transferred by the pattern portion 100. In this way, even when pattern transfer occurs in positions corresponding to the supplementary patterns 500 in the non-pattern portion 200, the function of the pattern circuit transferred onto the substrate is not affected by the pattern transfer, so that a pattern circuit normally performing a desired function can be achieved.

The width, shape, area, and the like of the supplementary pattern 500 may be appropriately determined in consideration of the viscosity and surface energy of ink 240 to be used, and the like. Also, the number of supplementary patterns 500 may be appropriately determined in consideration of the area of the non-pattern portion 200, and the like. For example, when the area of the non-pattern portion 200 is large, a larger number of supplementary patterns 500 shall be required to effectively remove the residual ink.

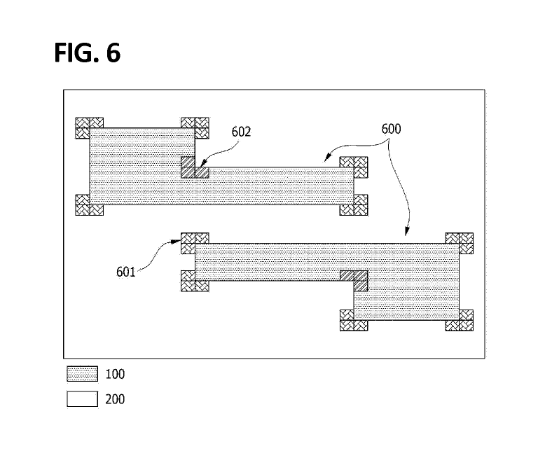

FIG. 6 is a sectional view of an intaglio printing plate including a pattern portion, which includes supplementary patterns formed in the vicinity of edges thereof, according to an embodiment of the present invention. Referring to FIG. 6, the pattern portion 600 including a supplementary pattern portion includes supplementary patterns 601, 602 in the vicinity of the edges of the pattern portion 100. The supplementary patterns are divided into a convex part-supplementary pattern 601 adjacent to the corner of a convex part of the pattern portion 100 and a concave part-supplementary pattern 602 adjacent to the corner of a concave part of the pattern portion 100.

In the conventional gravure offset printing process, there is a problem in that pattern transfer is not properly achieved in the vicinity of the edges of a pattern, including convex and concave parts. Herein, the convex part of a pattern refers to a pattern corner where two edges forming the corner have an interior angle of 180° or less, and the concave part of a pattern refers to a pattern corner where two edges forming the corner have an interior angle of 180° or greater.

In particular, the convex part formed by the edges of a pattern has a problem in that the amount of ink is insufficient. More specially, in view of the characteristics of ink, the amount of ink filled in the edge part of a pattern is insufficient as compared to the amount of ink filled in the central part of the pattern, and the vicinity of the edge part is dug into in the process of scraping off ink applied on the surface of an intaglio printing plate by a doctor blade. Further, in the process of drying ink after ink transfer, the printed pattern is distorted due to the shrinkage of the ink.

To solve these problems, the convex part-supplementary pattern 601 is formed in the vicinity of the convex part of the pattern portion 100, as shown in FIG. 6. The convex part-supplementary pattern 601 is formed in the non-pattern portion 200 while adjoining the outside of the convex part of the pattern portion 100. The convex part-supplementary pattern 601 is configured to additionally fill the convex part area, in which pattern transfer is properly achieved due to ink shortage, with ink.

In the case of gravure offset printing, for example, the convex part-supplementary pattern 601 may be configured to be filed with ink by being engraved in the form of an intaglio in the same manner as the pattern portion 100. Further, as shown in FIG. 6, the convex part-supplementary pattern 601 may include a combination of three fine square patterns adjoining the outside of the convex corner (convex part) of the pattern portion 100. The shape, area, groove depth, and the like of the convex part-supplementary pattern 601 may be appropriately determined in consideration of the viscosity and surface energy of ink to be used, and the like.

The concave part formed by the edges of a pattern is a crossing area of the pattern, and has a problem in that the amount of ink is excessive. More specially, ink spreading occurs during printing due to excess ink, which affects the transfer precision of a pattern. The concave part-supplementary pattern 602 is formed in the pattern portion 100 while adjoining the inside of the concave part of the pattern portion 100. The concave part-supplementary pattern 602 is configured to selectively reduce ink filling in the concave part area where pattern transfer is not properly achieved due to excess ink.

In the case of gravure offset printing, for example, the concave part-supplementary pattern 602 may be configured not to be filled with ink by being embossed in the form of a flat non-grooved plate in the same manner as the non-pattern portion 200. Further, as shown in FIG. 6, the concave part-supplementary pattern 602 may include a combination of three fine square patterns adjoining the inside of the concave part of the pattern portion 100. The shape and area of the concave part-supplementary pattern 602 may be appropriately determined in consideration of the viscosity and surface energy of ink, and the like.

The pattern portion 600 including the supplementary pattern portion, as shown in FIG. 6, is filled with ink all over the pattern portion 100 by the convex part-supplementary pattern 601 and the concave part-supplementary pattern 602 formed therein, and thus can achieve precise pattern transfer.

The intaglio printing plate including a supplementary pattern according to the present invention has the following advantageous effects: Firstly, a pattern of the intaglio printing plate can be filled with ink regardless of the direction of the pattern. Secondly, an edge portion of the pattern is also filled with a uniform amount of ink, so that the precision of the pattern can be enhanced. Thirdly, since pattern separation properties are improved by selectively forming the supplementary pattern, the transfer position of ink can be controlled and precise pattern transfer can be achieved.

Although specific embodiments of the present invention have been described for illustrative purposes, the present invention is not limited those embodiments, and various modifications, additions and substitutions are possible without departing from the scope and spirit of the invention as disclosed in the accompanying claims.

What is claimed is:

1. An intaglio printing plate comprising:
a pattern portion where a to-be-printed pattern is located;
a non-pattern portion corresponding to a remaining area other than the pattern portion; and
a supplementary pattern portion having a repetitive pattern with a predetermined form,
wherein at least a part of the pattern portion is divided by a pattern structure that is formed by the supplementary pattern portion.

2. The intaglio printing plate as claimed in claim 1, wherein a section of the repetitive pattern has a mesh structure.

3. The intaglio printing plate as claimed in claim 1, wherein the predetermined form is any one selected from the group consisting of a rectangle, a rhombus, and a hexagon.

4. The intaglio printing plate as claimed in claim 1, wherein the pattern portion has a structure in which a groove is engraved in the form of an intaglio, the supplementary pattern portion includes a plurality of posts embossed within the groove, and the plurality of posts have the same height as the groove of the pattern portion.

5. The intaglio printing plate as claimed in claim 4, wherein a sectional width of the plurality of posts is dimensioned such that the supplementary pattern portion is not printed when the intaglio printing plate is transferred onto a substrate.

6. The intaglio printing plate as claimed in claim 1, wherein the pattern portion has a groove structure in which a groove is engraved in the form of an intaglio, and the supplementary pattern portion is arranged only in an upper part of the groove of the pattern portion, as a result of which only the upper part of the groove of the pattern portion is divided by the supplementary pattern portion.

7. The intaglio printing plate as claimed in claim 1, wherein a surface of the supplementary pattern portion is made of the same material as the non-pattern portion.

8. The intaglio printing plate as claimed in claim 1, wherein the supplementary pattern portion includes several types of repetitive patterns.

9. An intaglio printing plate comprising:
a pattern portion where a to-be-printed pattern is located;
a non-pattern portion corresponding to a remaining area other than the pattern portion; and
at least one supplementary pattern formed in the non-pattern portion.
wherein the supplementary pattern is configured such that a pressure applied by a doctor blade moving in the non-pattern portion during ink filling is concentrated into the supplementary pattern.

10. The intaglio printing plate as claimed in claim 9, wherein the supplementary pattern is positioned in an area where a function of the pattern formed by the pattern portion is affected by the supplementary pattern.

11. The intaglio printing plate as claimed in claim 9, wherein the pattern portion and the supplementary pattern have a structure in which a groove is engraved in the form of an intaglio.

12. The intaglio printing plate as claimed in claim 9, wherein a plurality of supplementary patterns are arranged at regular intervals in the non-pattern portion.

13. An intaglio printing plate comprising:
a pattern portion where a to-be-printed pattern is located;
a non-pattern portion corresponding to a remaining area other than the pattern portion;
a first supplementary pattern portion adjoining an outside of a convex corner part of the pattern portion and located in an area of the non-pattern portion; and
a second supplementary pattern portion adjoining an inside of a concave corner part of the pattern portion and located in an area of the pattern portion
wherein the first supplementary pattern portion is configured to be filled with ink, and the second supplementary pattern portion is configured not to be filled with ink.

14. The intaglio printing plate as claimed in claim 13, wherein the pattern portion and the first supplementary pattern portion have a structure in which a groove is engraved in the form of an intaglio, and the non-pattern portion and the second supplementary pattern portion have a flat plate structure.

15. The intaglio printing plate as claimed in claim 13, wherein the first supplementary pattern portion includes three fine square patterns adjoining the outside of the convex corner part, and the second supplementary pattern portion includes three fine square patterns adjoining the inside of the concave corner part.
